(19) United States
(12) Patent Application Publication
(10) Pub. No.: US 2020/0193521 A1
(43) Pub. Date: Jun. 18, 2020

(54) CONTEXT-AWARE BLOCKCHAIN INSURANCE

(71) Applicant: NCR Corporation, Atlanta, GA (US)

(72) Inventor: Jennifer Elworthy, Kinfauns (GB)

(21) Appl. No.: 16/221,462

(22) Filed: Dec. 15, 2018

(51) Int. Cl. G06Q 40/08; H04W 4/029; H04W 4/021; H04W 4/44; H04L 9/06; G06F 16/18

(52) U.S. Cl. CPC G06Q 40/08; H04W 4/029; H04W 4/021; H04L 2209/38; H04L 9/0618; G06F 16/1805; H04W 4/44

(57) ABSTRACT

A system and method can automatically engage insurance coverage only when needed. A processor coupled to a sensor can automatically determine whether a sensed environmental condition satisfies at least one specified condition. When the sensed environmental condition satisfies the at least one specified condition, the processor can automatically engage insurance coverage corresponding to the specified condition by automatically initiating access of a blockchain ledger and automatically writing an engagement entry to the blockchain ledger, the engagement entry representing a date and time at which the insurance coverage is engaged. When the sensed environmental condition fails to satisfy the at least one specified condition, the processor can automatically disengage insurance coverage corresponding to the specified condition by automatically initiating access of the blockchain ledger and automatically writing a disengagement entry to the blockchain ledger, the disengagement entry representing a date and time at which the insurance coverage is disengaged.

### FIELD OF THE DISCLOSURE

The present disclosure relates generally to a blockchain ledger that can automatically document times of engagement and disengagement of insurance coverage.

### BACKGROUND OF THE DISCLOSURE

Insurance may not be required during times of low-risk conditions. For example, collision insurance for an automobile may not be required during a time that the automobile is parked in the automobile owner's garage.

### BRIEF DESCRIPTION OF THE DRAWINGS

FIG. 1 shows an example of a system for automatically engaging insurance coverage only when needed, in accordance with some embodiments.

FIG. 2 shows a flowchart of an example of a method for automatically engaging insurance coverage only when needed, in accordance with some embodiments.

FIG. 3 shows a block diagram of an example of a controller, in accordance with some embodiments.

Corresponding reference characters indicate corresponding parts throughout the several views. Elements in the drawings are not necessarily drawn to scale. The configurations shown in the drawings are merely examples, and should not be construed as limiting the scope of the inventive subject matter in any manner.

### DETAILED DESCRIPTION

A system and method can automatically engage insurance coverage only when needed. A processor coupled to a sensor can automatically determine whether at least one sensed environmental condition satisfies at least one specified condition. When the sensed environmental condition satisfies the at least one specified condition, the processor can automatically engage insurance coverage corresponding to the specified condition by automatically initiating access of a blockchain ledger and automatically writing an engagement entry to the blockchain ledger, the engagement entry representing a date and time at which the insurance coverage is engaged. When the sensed environmental condition fails to satisfy the at least one specified condition, the processor can automatically disengage insurance coverage corresponding to the specified condition by automatically initiating access of the blockchain ledger and automatically writing a disengagement entry to the blockchain ledger, the disengagement entry representing a date and time at which the insurance coverage is disengaged.

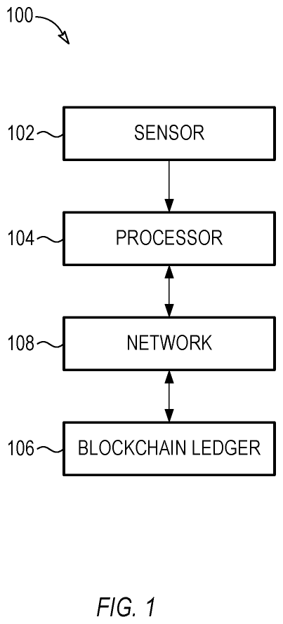

FIG. 1 shows an example of a system 100 for automatically engaging insurance coverage only when needed, in accordance with some embodiments. The configuration of FIG. 1 is but one example; other suitable systems can also be used.

A sensor 102 can automatically sense at least one environmental condition. Examples of suitable sensors can include a location sensor based on Global Positioning System (GPS), a location sensor based on triangulation to cellular phone towers, a location sensor based on visual inspection of the surroundings of the location sensor, a velocity or speed sensor based on Global Positioning System (GPS), a velocity or speed sensor based on triangulation to cellular phone towers, a velocity or speed sensor based on visual inspection of the surroundings of the velocity or speed sensor, a velocity or speed sensor based on a gyroscope, a position sensor that can determine if a door is open or closed, a position sensor that can sense a motion of door, a position sensor that can determine if an animal or person is exiting a house or entering the house, an environmental sensor that can measure one or more of temperature, humidity, barometric pressure, precipitation, wind speed, or sky conditions such as brightness or cloud cover, an environmental sensor coupled to an internet-based weather service, or others. The system can optionally include more than one sensor, and can optionally include sensors of different types.

A processor 104 coupled to the sensor 102 can automatically determine whether the sensed at least one environmental condition satisfies at least one specified condition. Examples of suitable specified conditions can include whether a sensor is positioned inside or outside a garage, whether a sensor is moving or stationary, how long a sensor has been stationary, whether an animal or person is inside or outside a house, whether a weather condition of a house or property is stormy or clear, or others. The sensed conditions can optionally be grouped to simultaneously satisfy more than one specified condition. For example, the at least one condition can include being positioned outside a garage, and simultaneously having stormy weather. Other combinations can also be used.

When the at least one sensed environmental condition satisfies the at least one specified condition, the processor 104 can automatically engage insurance coverage corresponding to the specified condition by automatically initiating access of a blockchain ledger 106 and automatically writing an engagement entry to the blockchain ledger. The engagement entry can represent a date and time at which the insurance coverage is engaged. The processor 104 can communicate with the blockchain ledger 106 through appropriate networks 108 and servers.

When the at least one sensed environmental condition fails to satisfy the at least one specified condition, the processor 104 can automatically disengage insurance coverage corresponding to the specified condition by automatically initiating access of the blockchain ledger 106 and automatically writing a disengagement entry to the blockchain ledger 106. The disengagement entry can represent a date and time at which the insurance coverage is disengaged.

The blockchain ledger 106 can prove that the insurance coverage is engaged or is disengaged at any particular time. For example, to resolve an insurance claim for an event, an insurance company can check the blockchain ledger 106 to determine if coverage is engaged at the time of the event.

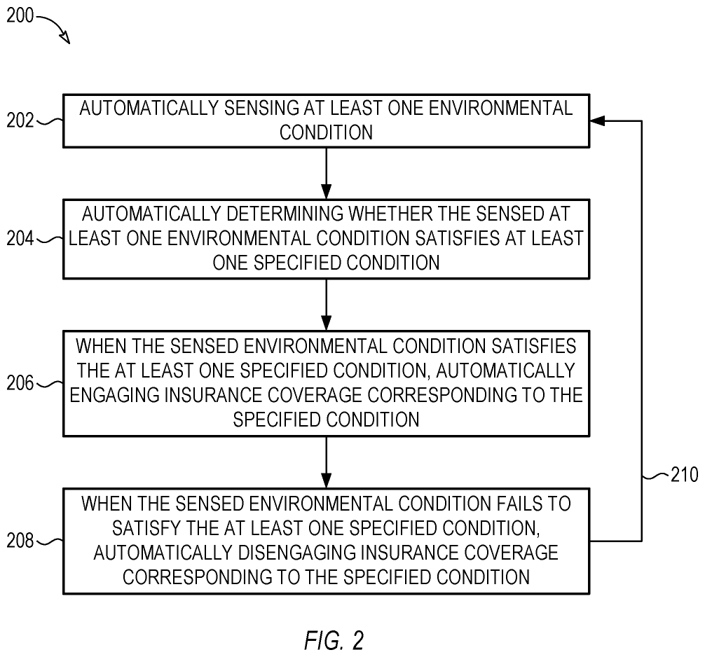

FIG. 2 shows a flowchart of an example of a method 200 for automatically engaging insurance coverage only when needed, in accordance with some embodiments. The method of FIG. 2 is but one example of a method for automatically engaging insurance coverage only when needed; other suitable methods can also be used.

At operation 202, the method 200 can include automatically sensing at least one environmental condition.

At operation 204, the method 200 can include automatically determining whether the sensed at least one environmental condition satisfies at least one specified condition.

At operation 206, the method 200 can include, when the sensed environmental condition satisfies the at least one specified condition, automatically engaging insurance coverage corresponding to the specified condition.

At operation 208, the method 200 can include, when the sensed environmental condition fails to satisfy the at least one specified condition, automatically disengaging insurance coverage corresponding to the specified condition.

At operation 210, the method 200 can include repeating operations 202 through 208, as needed. In some examples, the repetition is regular, such as with a specified periodicity, such as every minute, every five minutes, twice an hour, and so forth. In some examples, the repetition can be irregular. In some examples, the repetition can be triggered by movement of a mobile phone from one location to another. Other configurations can also be used.

In some examples, automatically engaging the insurance coverage can include: automatically initiating access of a blockchain ledger, and automatically writing an engagement entry to the blockchain ledger. The engagement entry can represent a date and time at which the insurance coverage is engaged.

In some examples, automatically disengaging the insurance coverage can include: automatically initiating access of the blockchain ledger, and automatically writing a disengagement entry to the blockchain ledger. The disengagement entry can represent a date and time at which the insurance coverage is disengaged.

In some examples, the at least one environmental condition can be automatically sensed by a smart phone. The smart phone can automatically determine whether the sensed at least one environmental condition satisfies the at least one specified condition.

In some examples, the insurance coverage can be vehicle insurance coverage. The at least one environmental condition can include a location of a vehicle. Satisfying the specified condition can include determining that the vehicle is located outside of a garage.

In some examples, the location of the vehicle can be automatically sensed by a mobile device owned or operated by an owner or operator of the vehicle. Determining whether the vehicle is located outside of the garage can be performed by the mobile device.

In some examples, the mobile device can be a smart phone owned or operated by the owner or operator of the vehicle.

In some examples, the location of the vehicle can be automatically sensed by a wireless location sensor attached to the vehicle. Determining whether the vehicle is located outside of the garage can be performed by a processor based on a location provided by the wireless location sensor.

In some examples, the insurance coverage can be vehicle insurance coverage. The at least one environmental condition can include a speed of a vehicle. Satisfying the specified condition can include determining that the vehicle is moving or has been stationary for less than a specified duration. For example, if a vehicle has been stationary for an hour (or another suitable duration), it can be assumed that the vehicle is parked and is not being driven, and that insurance of the vehicle can be disengaged.

In some examples, the speed of the vehicle can be automatically sensed by a wireless velocity sensor attached to the vehicle. Determining whether the vehicle is moving or has been stationary for less than the specified duration can be performed by a processor based on data provided by the wireless velocity sensor.

In some examples, the insurance coverage can be pet insurance coverage. The at least one environmental condition can include a location of a pet. Satisfying the specified condition can include determining that the pet is located outside a house.

In some examples, the location of the pet can be automatically sensed by a wireless location sensor attached to the pet. Determining whether the pet is located outside the house can be performed by a processor based on data provided by the wireless location sensor.

In some examples, the location of the pet can be automatically sensed by a sensor attached to a pet door on an exterior of the house. Determining whether the pet is located outside the house is performed by a processor based on data provided by the sensor.

In some examples, the insurance coverage can be homeowner's coverage of a house. The at least one environmental condition can include a weather condition at the house. Satisfying the specified condition can include determining that the weather proximate the house is stormy.

In some examples, the weather condition can be automatically determined from an internet-based weather service. Determining that the weather proximate the house is stormy can be performed by a processor based on data provided by the internet-based weather service.

In some examples, the weather condition can be automatically determined from a wireless weather sensor mounted outside at or near the house. Determining that the weather proximate the house is stormy can be performed by a processor based on data provided by the wireless weather sensor.

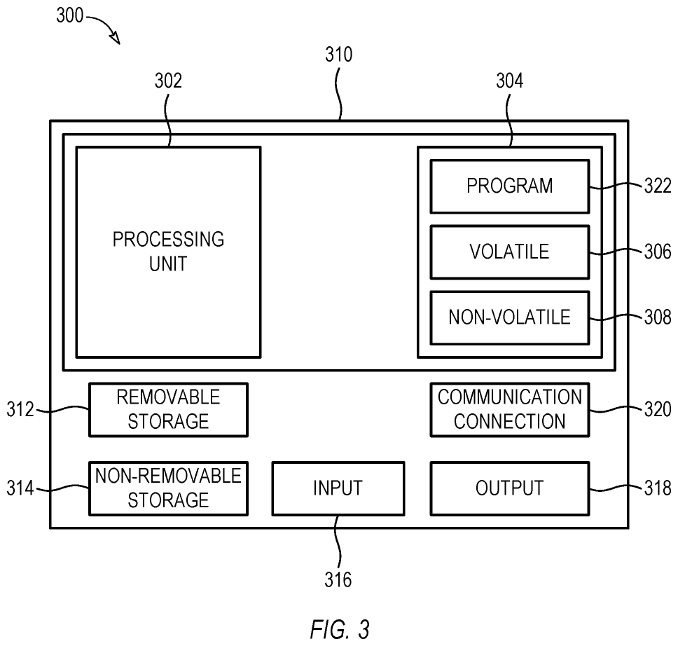

FIG. 3 shows a block diagram of an example of a controller 300, in accordance with some embodiments. The controller 300 can be part of a system that can automatically engage insurance coverage only when needed. The example of FIG. 3 is but one configuration for a controller; other configurations can also be used.

In one example, multiple such controllers 300 are utilized in a distributed network to implement multiple components in a transaction based environment. An object-oriented, service-oriented, or other architecture may be used to implement such functions and communicate between the multiple controllers 300 and components.

One example of a controller 300, in the form of a computer 310, can include a processing unit 302, memory 304, removable storage 312, and non-removable storage 314. Memory 304 may include volatile memory 306 and non-volatile memory 308. Computer 310 may include, or have access to a computing environment that includes, a variety of computer-readable media, such as volatile memory 306 and non-volatile memory 308, removable storage 312 and non-removable storage 314. Computer storage includes random access memory (RAM), read only memory (ROM), erasable programmable read-only memory (EPROM) and electrically erasable programmable read-only memory (EEPROM), flash memory or other memory technologies, compact disc read-only memory (CD-ROM), Digital Versatile Disks (DVD) or other optical disk storage, magnetic cassettes, magnetic tape, magnetic disk storage or other magnetic storage devices, or any other medium capable of storing computer-readable instructions. Computer 310 may include or have access to a computing environment that includes input 316, output 318, and a communication connection 320. The input 316 can include a video interface. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 302 of the computer 310. A hard drive, CD-ROM, and RAM are some examples of articles including a non-transitory computer-readable medium. For example, a computer program 322 with instructions for the computer 310, according to the teachings of the present disclosure, may be included on a CD-ROM and loaded from the CD-ROM to a hard drive. The computer-readable instructions allow computer 310 to provide generic access controls in a COM based computer network system having multiple users and servers.

In the foregoing detailed description, the method and apparatus of the present disclosure have been described with reference to specific embodiments thereof. It will, however, be evident that various modifications and changes may be made thereto without departing from the broader spirit and scope of the present disclosure. The present specification and figures are accordingly to be regarded as illustrative rather than restrictive.

To further illustrate the device and related method disclosed herein, a non-limiting list of examples is provided below. Each of the following non-limiting examples can stand on its own, or can be combined in any permutation or combination with any one or more of the other examples.

In Example 1, a method for automatically engaging insurance coverage only when needed can include, repeatedly: automatically sensing at least one environmental condition; automatically determining whether the sensed at least one environmental condition satisfies at least one specified condition; when the sensed environmental condition satisfies the at least one specified condition, automatically engaging insurance coverage corresponding to the specified condition; and when the sensed environmental condition fails to satisfy the at least one specified condition, automatically disengaging insurance coverage corresponding to the specified condition.

In Example 2, the method of Example 1 can optionally be configured such that automatically engaging the insurance coverage comprises: automatically initiating access of a blockchain ledger; automatically writing an engagement entry to the blockchain ledger, the engagement entry representing a date and time at which the insurance coverage is engaged.

In Example 3, the method of any one of Examples 1-2 can optionally be configured such that automatically disengaging the insurance coverage comprises: automatically initiating access of the blockchain ledger; and automatically writing a disengagement entry to the blockchain ledger, the disengagement entry representing a date and time at which the insurance coverage is disengaged.

In Example 4, the method of any one of Examples 1-3 can optionally be configured such that the at least one environmental condition is automatically sensed by a smart phone; and the smart phone is further configured to automatically determining whether the sensed at least one environmental condition satisfies the at least one specified condition.

In Example 5, the method of any one of Examples 1-4 can optionally be configured such that the insurance coverage is vehicle insurance coverage; the at least one environmental condition comprises a location of a vehicle; and satisfying the specified condition comprises determining that the vehicle is located outside of a garage.

In Example 6 the method of any one of Examples 1-5 can optionally be configured such that the location of the vehicle is automatically sensed by a mobile device owned or operated by an owner or operator of the vehicle; and determining whether the vehicle is located outside of the garage is performed by the mobile device.

In Example 7, the method of any one of Examples 1-6 can optionally be configured such that the mobile device is a smart phone owned or operated by the owner or operator of the vehicle.

In Example 8, the method of any one of Examples 1-7 can optionally be configured such that the location of the vehicle is automatically sensed by a wireless location sensor attached to the vehicle; and determining whether the vehicle is located outside of the garage is performed by a processor based on a location provided by the wireless location sensor.

In Example 9, the method of any one of Examples 1-8 can optionally be configured such that the insurance coverage is vehicle insurance coverage; the at least one environmental condition comprises a speed of a vehicle; and satisfying the specified condition comprises determining that the vehicle is moving or has been stationary for less than a specified duration.

In Example 10, the method of any one of Examples 1-9 can optionally be configured such that the speed of the vehicle is automatically sensed by a wireless velocity sensor attached to the vehicle; and determining whether the vehicle is moving or has been stationary for less than the specified duration is performed by a processor based on data provided by the wireless velocity sensor.

In Example 11, the method of any one of Examples 1-10 can optionally be configured such that the insurance coverage is pet insurance coverage; the at least one environmental condition comprises a location of a pet; and satisfying the specified condition comprises determining that the pet is located outside a house.

In Example 12, the method of any one of Examples 1-11 can optionally be configured such that the location of the pet is automatically sensed by a wireless location sensor attached to the pet; and determining whether the pet is located outside the house is performed by a processor based on data provided by the wireless location sensor.

In Example 13, the method of any one of Examples 1-12 can optionally be configured such that the location of the pet is automatically sensed by a sensor attached to a pet door on an exterior of the house; and determining whether the pet is located outside the house is performed by a processor based on data provided by the sensor.

In Example 14, the method of any one of Examples 1-13 can optionally be configured such that the insurance coverage is homeowner's coverage of a house; the at least one environmental condition comprises a weather condition at the house; and satisfying the specified condition comprises determining that the weather proximate the house is stormy.

In Example 15, the method of any one of Examples 1-14 can optionally be configured such that the weather condition is automatically determined from an internet-based weather service; and determining that the weather proximate the house is stormy is performed by a processor based on data provided by the internet-based weather service.

In Example 16, the method of any one of Examples 1-15 can optionally be configured such that the weather condition is automatically determined from a wireless weather sensor mounted outside at or near the house; and determining that the weather proximate the house is stormy is performed by a processor based on data provided by the wireless weather sensor.

In Example 17, a system for automatically engaging insurance coverage only when needed can include: a sensor configured to automatically sense at least one environmental condition; and a processor coupled to the sensor and configured to automatically determine whether the sensed at least one environmental condition satisfies at least one specified condition; wherein when the sensed environmental condition satisfies the at least one specified condition, the processor is configured to automatically engage insurance coverage corresponding to the specified condition by automatically initiating access of a blockchain ledger and automatically writing an engagement entry to the blockchain ledger, the engagement entry representing a date and time at which the insurance coverage is engaged; and wherein when the sensed environmental condition fails to satisfy the at least one specified condition, the processor is configured to automatically disengage insurance coverage corresponding to the specified condition by automatically initiating access of the blockchain ledger and automatically writing a disengagement entry to the blockchain ledger, the disengagement entry representing a date and time at which the insurance coverage is disengaged.

In Example 18, the system of Example 17 can optionally further include a smart phone that includes the sensor and the processor.

In Example 19, a method for automatically engaging insurance coverage only when needed can include: automatically sensing at least one environmental condition; automatically determining whether the sensed at least one environmental condition satisfies at least one specified condition; when the sensed environmental condition satisfies the at least one specified condition, automatically engaging insurance coverage corresponding to the specified condition by automatically initiating access of a blockchain ledger and automatically writing an engagement entry to the blockchain ledger, the engagement entry representing a date and time at which the insurance coverage is engaged; and when the sensed environmental condition fails to satisfy the at least one specified condition, automatically disengaging insurance coverage corresponding to the specified condition by automatically initiating access of the blockchain ledger and automatically writing a disengagement entry to the blockchain ledger, the disengagement entry representing a date and time at which the insurance coverage is disengaged.

In Example 20, the method of Example 19 can optionally be further configured such that the at least one environmental condition is automatically sensed by a smart phone; and the smart phone is further configured to automatically determining whether the sensed at least one environmental condition satisfies the at least one specified condition.

What is claimed is:

1. A method for automatically engaging insurance coverage only when needed, the method comprising, repeatedly:
automatically sensing at least one environmental condition;
automatically determining whether the sensed at least one environmental condition satisfies at least one specified condition;
when the sensed environmental condition satisfies the at least one specified condition, automatically engaging insurance coverage corresponding to the specified condition; and
when the sensed environmental condition fails to satisfy the at least one specified condition, automatically disengaging insurance coverage corresponding to the specified condition.

2. The method of claim 1, wherein automatically engaging the insurance coverage comprises:
automatically initiating access of a blockchain ledger; and
automatically writing an engagement entry to the blockchain ledger, the engagement entry representing a date and time at which the insurance coverage is engaged.

3. The method of claim 2, wherein automatically disengaging the insurance coverage comprises:
automatically initiating access of the blockchain ledger; and
automatically writing a disengagement entry to the blockchain ledger, the disengagement entry representing a date and time at which the insurance coverage is disengaged.

4. The method of claim 1, wherein:
the at least one environmental condition is automatically sensed by a smart phone; and
the smart phone is further configured to automatically determining whether the sensed at least one environmental condition satisfies the at least one specified condition.

5. The method of claim 1, wherein:
the insurance coverage is vehicle insurance coverage;
the at least one environmental condition comprises a location of a vehicle; and
satisfying the specified condition comprises determining that the vehicle is located outside of a garage.

6. The method of claim 5, wherein:
the location of the vehicle is automatically sensed by a mobile device owned or operated by an owner or operator of the vehicle; and
determining whether the vehicle is located outside of the garage is performed by the mobile device.

7. The method of claim 6, wherein the mobile device is a smart phone owned or operated by the owner or operator of the vehicle.

8. The method of claim 5, wherein:
the location of the vehicle is automatically sensed by a wireless location sensor attached to the vehicle; and
determining whether the vehicle is located outside of the garage is performed by a processor based on a location provided by the wireless location sensor.

9. The method of claim 1, wherein:
the insurance coverage is vehicle insurance coverage;
the at least one environmental condition comprises a speed of a vehicle; and
satisfying the specified condition comprises determining that the vehicle is moving or has been stationary for less than a specified duration.

10. The method of claim 9, wherein:
the speed of the vehicle is automatically sensed by a wireless velocity sensor attached to the vehicle; and
determining whether the vehicle is moving or has been stationary for less than the specified duration is performed by a processor based on data provided by the wireless velocity sensor.

11. The method of claim 1, wherein:
the insurance coverage is pet insurance coverage;
the at least one environmental condition comprises a location of a pet; and
satisfying the specified condition comprises determining that the pet is located outside a house.

12. The method of claim 11, wherein:
the location of the pet is automatically sensed by a wireless location sensor attached to the pet; and
determining whether the pet is located outside the house is performed by a processor based on data provided by the wireless location sensor.

13. The method of claim 11, wherein:
the location of the pet is automatically sensed by a sensor attached to a pet door on an exterior of the house; and
determining whether the pet is located outside the house is performed by a processor based on data provided by the sensor.

14. The method of claim 1, wherein:
the insurance coverage is homeowner's coverage of a house;
the at least one environmental condition comprises a weather condition at the house; and
satisfying the specified condition comprises determining that the weather proximate the house is stormy.

15. The method of claim 14, wherein:
the weather condition is automatically determined from an internet-based weather service; and
determining that the weather proximate the house is stormy is performed by a processor based on data provided by the internet-based weather service.

16. The method of claim 14, wherein:
the weather condition is automatically determined from a wireless weather sensor mounted outside at or near the house; and
determining that the weather proximate the house is stormy is performed by a processor based on data provided by the wireless weather sensor.

17. A system for automatically engaging insurance coverage only when needed, the system comprising:
a sensor configured to automatically sense at least one environmental condition; and
a processor coupled to the sensor and configured to automatically determine whether the sensed at least one environmental condition satisfies at least one specified condition;
wherein when the sensed environmental condition satisfies the at least one specified condition, the processor is configured to automatically engage insurance coverage corresponding to the specified condition by automatically initiating access of a blockchain ledger and automatically writing an engagement entry to the blockchain ledger, the engagement entry representing a date and time at which the insurance coverage is engaged; and
wherein when the sensed environmental condition fails to satisfy the at least one specified condition, the processor is configured to automatically disengage insurance coverage corresponding to the specified condition by automatically initiating access of the blockchain ledger and automatically writing a disengagement entry to the blockchain ledger, the disengagement entry representing a date and time at which the insurance coverage is disengaged.

18. The system of claim 17, further comprising a smart phone that includes the sensor and the processor.

19. A method for automatically engaging insurance coverage only when needed, the method comprising:
automatically sensing at least one environmental condition;
automatically determining whether the sensed at least one environmental condition satisfies at least one specified condition;
when the sensed environmental condition satisfies the at least one specified condition, automatically engaging insurance coverage corresponding to the specified condition by automatically initiating access of a blockchain ledger and automatically writing an engagement entry to the blockchain ledger, the engagement entry representing a date and time at which the insurance coverage is engaged; and
when the sensed environmental condition fails to satisfy the at least one specified condition, automatically disengaging insurance coverage corresponding to the specified condition by automatically initiating access of the blockchain ledger and automatically writing a disengagement entry to the blockchain ledger, the disengagement entry representing a date and time at which the insurance coverage is disengaged.

20. The method of claim 19, wherein:
the at least one environmental condition is automatically sensed by a smart phone; and
the smart phone is further configured to automatically determining whether the sensed at least one environmental condition satisfies the at least one specified condition.
